(19) United States
(12) Patent Application Publication
(10) Pub. No.: US 2024/0203273 A1
(43) Pub. Date: Jun. 20, 2024

(54) Method And System For Assisting A Pilot Of An Aircraft When The Aircraft Is Taxiing On A Traffic Lane Of An Airport

(71) Applicant: Airbus Operations SAS, Toulouse (FR)

(72) Inventors: Jean-Claude Mere, Toulouse (FR); Mathieu Rustin, Toulouse (FR); Emilie Claudel, Toulouse (FR); Isabelle Sentissi, Toulouse (FR); Louise Faure, Toulouse (FR); Thierry Sammour Sawaya, Toulouse (FR)

(73) Assignee: Airbus Operations SAS, Toulouse (FR)

(21) Appl. No.: 18/534,966

(22) Filed: Dec. 11, 2023

(30) Foreign Application Priority Data
Dec. 16, 2022 (FR) 2213621

(51) Int. Cl. G08G 5/06; G08G 5/00

(52) U.S. Cl. CPC G08G 5/065; G08G 5/0021; G08G 5/0078

(57) ABSTRACT

A method and system for assisting a pilot of an aircraft when the aircraft is taxiing on a traffic lane of an airport are described. The system includes a unit for receiving at least a part of a path (TR) to be followed by the aircraft (AC) on the airport, a unit for surveying the airport so as to be able to detect a characteristic element of a traffic lane taken by the aircraft (AC), to determine a current relative position of the aircraft (AC) with respect to the characteristic element detected and to deduce therefrom at least one assistance information item, and a unit for assisting the pilot of the aircraft (AC) when taxiing on the airport by taking into account at least this assistance information item, this assistance being able to be implemented according to a plurality of different, more or less automated, assistance modes.

### FIELD OF THE INVENTION

The present invention relates to a method and a system for assisting a pilot of an aircraft when the aircraft is taxiing on a traffic lane of an airport.

In the context of the present invention, a traffic lane of an airport is understood to be a runway (intended for aircraft to land and/or take off) or another taxiway of the airport which is notably used by the aircraft to follow the path between a runway and a parking zone.

The present invention applies more particularly to a phase of taxiing on such a traffic lane of the airport.

### BACKGROUND OF THE INVENTION

Currently, there is no certified function which fully assists the pilot of an aircraft taxiing on an airport to assist him or her in following the path as required.

### BRIEF SUMMARY OF THE INVENTION

So, it could be useful to have a solution that makes it possible to assist a pilot of an aircraft in a “taxiing” type running phase.

One objective of the present invention is to provide such a solution. To do this, the present invention relates to a method for assisting a pilot of an aircraft when the aircraft is taxiing on a traffic lane of an airport.

According to an aspect of the invention, said method comprises at least the following steps:
a surveillance step, implemented by a surveillance unit, at least to survey the airport so as to be able to detect at least one characteristic element of a traffic lane (taken by the aircraft) of the airport, to determine a current relative position of the aircraft with respect to the characteristic element detected, and to deduce therefrom at least one so-called assistance information item; and
an assistance step, implemented by at least one assistance unit, at least to assist the pilot of the aircraft when the aircraft is taxiing on the airport (in order to have the aircraft follow a path) by taking into account at least said assistance information item.

The method is implemented in a “taxiing” type running phase.

Thus, said method is able, during the taxiing phase, to assist the pilot of the aircraft to assist him or her in having the aircraft follow the path (heading or route) which is assigned to it, this assistance being able to be implemented according to one of a plurality of different assistance modes, more or less automated, that is to say requiring greater or lesser intervention from the pilot of the aircraft, as specified hereinbelow.

Advantageously, the surveillance step comprises a data reception step comprising at least one odometry step at least to implement a visual odometry in order to determine at least the position of the aircraft (and generally its dynamics) notably making it possible to obtain said current relative position of the aircraft.

Preferably, said method also comprises a path reception step, implemented by a reception unit, for receiving at least a part of the path to be followed by the aircraft on the airport. Advantageously, the path reception step comprises the reception of one of the following information items representing at least said part of path:
the heading to be followed by the aircraft;
the route to be followed by the aircraft.

Advantageously, the surveillance step comprises a data reception step comprising at least one of the following steps:
an optical detection step comprising an imaging substep at least to take images of the environment outside of the aircraft and an image processing substep at least for processing at least some of the images taken in said imaging substep so as to detect at least one characteristic element relating to a traffic lane, represented in one of said processed images:
the odometry step at least to implement a visual odometry at least to determine a movement (position and speed) of the aircraft;
a radar detection step at least to detect a limit between a zone provided with a coating for taxiing on the traffic lane and a zone without any coating for taxiing.

Furthermore, advantageously, the surveillance step comprises at least one of the following steps:
a data reception step comprising the reception of position information from at least one of the following data sources of the aircraft: an inertial reference system, a satellite positioning system, an odometer, a tachymeter, an optoelectronic sensor, this position information making it possible to determine an absolute position of the aircraft;
a data processing step at least to determine a consolidated absolute position of the aircraft, by using position information from a plurality of different data sources.

In addition, advantageously, the surveillance step comprises at least:
a data reception step comprising the reception of data relating to at least one of the following characteristic elements of the traffic lane:
a centerline of the traffic lane;
at least one edge line of the traffic lane;
at least one limit between a zone provided with a coating for taxiing on the traffic lane and a zone without any coating for taxiing; and
a data processing step at least for processing the data received in the data reception step so as to determine the current relative position of the aircraft with respect to the characteristic element and to deduce, if necessary, a current deviation of the aircraft with respect to the path to be followed, said current deviation representing the assistance information item.

Furthermore, advantageously, the surveillance step comprises at least:
a data reception step comprising the reception of data relating to one or more characteristic elements comprising a mandatory characteristic element corresponding to a stop marking on the ground, said characteristic element or elements relating to a taxi-holding position of a runway of the airport; and
a data processing step at least to determine, from the data received in the data reception step and a possible authorization from air traffic control, an authorization or a prohibition to enter onto the runway, said authorization or said prohibition representing the assistance information item.

In a preferred embodiment, the surveillance step uses a dynamic map of the airport (“Dynamic Airport Map”).

Moreover, in a first embodiment, the assistance step comprises at least a step (of presentation of information) at least to present, notably to display, piloting assistance and/or ground navigation assistance information in the cockpit of the aircraft (for example via a display of head-up type or a display of head-down type).

Furthermore, in a second embodiment, as a variant or complementing the abovementioned first embodiment, the assistance step comprises at least one step for implementing an at least partially automatic piloting of the aircraft.

In this second embodiment, the assistance step can be performed according to one of four different variants (of embodiment). Advantageously, the assistance step comprises:
in a first variant, a heading-maintaining substep at least to have the aircraft automatically maintain a heading to be followed, received in the reception step;
in a second variant, a straight-line-following substep at least to have the aircraft automatically follow a straight line, received in the reception step;
in a third variant, a straight-line-following and speed management substep to have both the aircraft automatically follow a straight line, received in the reception step, and an automatic management of the speed of the aircraft; and
in a fourth variant, an automatic piloting substep at least to implement an automatic piloting of the aircraft to follow a route, received in the reception step.

The present invention relates also to a system for assisting a pilot of an aircraft when the aircraft is taxiing on a traffic lane of an airport.

According to the invention, said assistance system (intended to be mounted on the aircraft) comprises at least:
a surveillance unit configured to survey the airport so as to be able to detect at least one characteristic element of a traffic lane of the airport, to determine a current relative position of the aircraft with respect to the characteristic element detected, and to deduce therefrom at least one so-called assistance information item; and
a so-called assistance unit configured to assist the pilot of the aircraft when taxiing on the airport (in order to have the aircraft follow a path) by taking into account at least said assistance information item.

Advantageously, the surveillance unit comprises at least one odometer at least to implement a visual odometry in order to determine at least the position of the aircraft making it possible notably to obtain said current relative position of the aircraft.

Preferably, said assistance system comprises a reception unit configured to receive at least a part of a path to be followed by the aircraft on the airport.

The present invention relates also to an aircraft, in particular a transport airplane, which comprises at least one assistance system, such as that described hereinabove.

### BRIEF DESCRIPTION OF THE DRAWINGS

The attached figures will give a good understanding of how the invention can be implemented. In these figures, identical references denote similar elements.

FIG. 1 is the block diagram of an assistance system, according to a particular embodiment of the invention.

FIG. 2 is a perspective schematic view of a part of an airport on which an aircraft equipped with an assistance system is taxiing.

FIG. 3 schematically illustrates the main steps of an assistance method, according to a particular embodiment of the invention.

### DETAILED DESCRIPTION

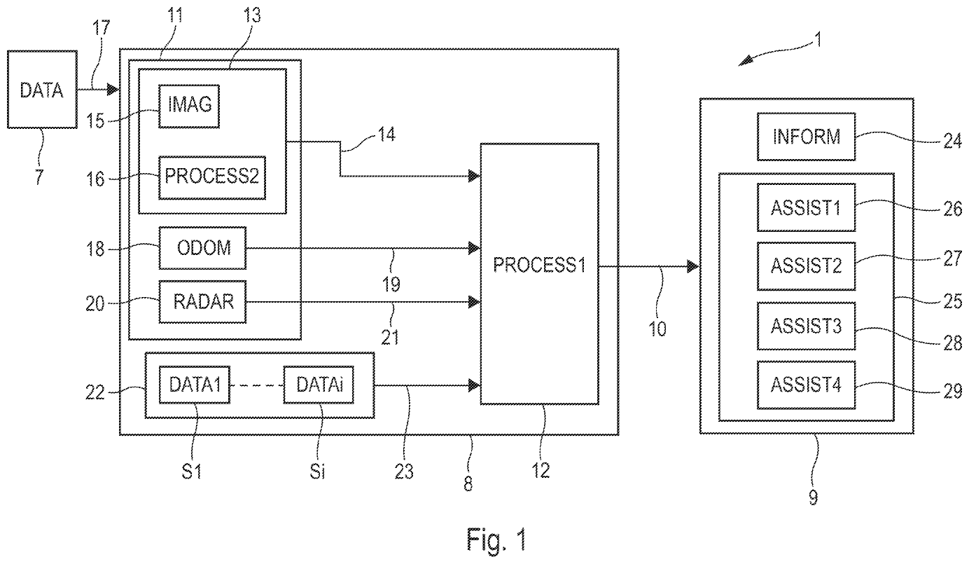

The system 1, represented schematically in FIG. 1 and that makes it possible to illustrate the invention, is intended to equip an aircraft AC, in particular a transport airplane.

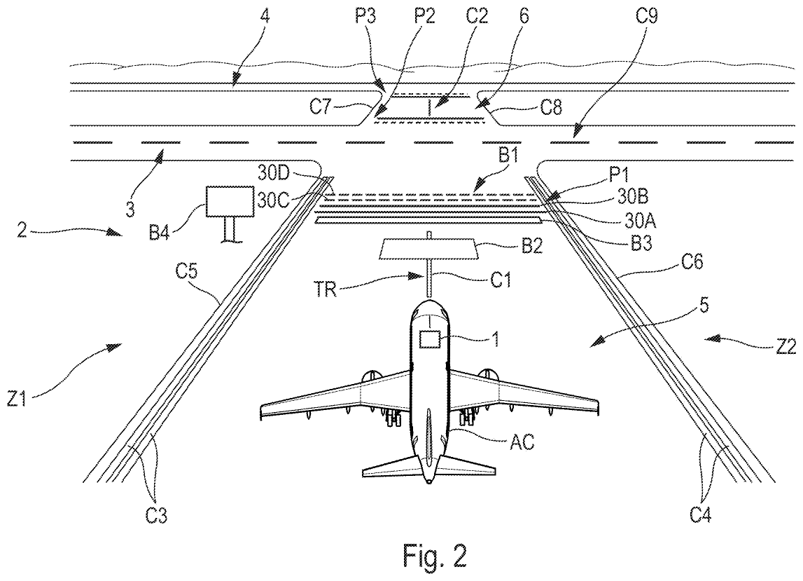

This system 1 (which is embedded on the aircraft AC, as represented very schematically in FIG. 2) is intended to assist the pilot of the aircraft AC, notably when it is taxiing on traffic lane of an airport 2, as in the example of FIG. 2.

In the context of the present invention, a traffic lane of an airport 2 corresponds, as represented in FIG. 2:
either to a runway, such as runways 3 and 4, which is intended for aircraft to take off and/or to land;
or to a taxiway, such as taxiways 5 and 6, which allows an aircraft to travel on the airport 2 notably to follow the path (by taxiing) between a runway (such as the runway 3 or 4) used for take-off or landing and a parking zone (not represented).

In the example of FIG. 2, the aircraft AC runs on the taxiway 5 to the runway 3.

Some modes of implementation of the present invention use, as specified hereinbelow:
so-called characteristic elements which relate to traffic lanes of the airport and which are identified by references Cn in the following description, n being an integer; and/or
so-called characteristic elements which relate to a taxi-holding position Pi (i being an integer) of taxiways and which are identified by references Bm in the following description, m being an integer. A taxi-holding position Pi is a point of a taxiway at which the aircraft AC waits (stops) before entering into an adjacent runway, as illustrated for taxi-holding positions P1, P2 and P3 in FIG. 2.

FIG. 2 represents, as a nonlimiting illustration, examples of characteristic elements Cn and examples of characteristic elements Bm.

Thus, more specifically, in the example of FIG. 2, the taxiway 5 is provided with a centerline C1 (or central axis), for example in yellow, and it is delimited laterally, on either side, by double lane-edge lines C3 and C4, for example also in yellow. FIG. 2 also shows a centerline C2 of the taxiway 6 and a centerline C9 of the runway 3, and lines C5 and C6 between a zone (namely the runway 3) provided with a coating for taxiing and a zone Z1, Z2 without any such coating.

Furthermore, in the example of FIG. 2, also represented, for the taxi-holding position P1 of the runway 3, are
a stop marking B1 on the ground, which represents a mandatory characteristic element;
an auxiliary marking B2 on the ground;
a light indicator B3 associated with the stop marking B1 on the ground; and
an instruction panel B4.

The system 1 is active on the aircraft AC during a taxiing phase of the aircraft AC, as in the example of FIG. 2.

Said system 1 comprises, as represented in FIG. 1:
a reception unit 7 configured to receive at least a part of a path TR to be followed by the aircraft AC on the airport 2 (FIG. 2);
a surveillance unit 8 linked via a link 17 to the reception unit 7 and configured:
to survey the airport 2 so as to be able to detect at least one characteristic element of a traffic lane 5 taken by the aircraft AC, namely at least one characteristic element Bm (m being an integer) and/or at least one characteristic element Cn (n being an integer) as a function of the embodiment envisaged, as specified hereinbelow;
to determine a current relative position of the aircraft AC with respect to the characteristic element Bm detected and/or to the characteristic element Cn detected; and
to deduce therefrom at least one so-called assistance information item; and
an assistance unit 9 linked via a link 10 to the surveillance unit 8 and configured to assist the pilot of the aircraft AC when taxiing on the airport 2, by taking into account at least said assistance information item (received from the surveillance unit 8).

The reception unit 7 is configured to make it possible to enter into the system 1 data (DATA for “data entering device”) and notably one of the following information items representing at least a part of path TR: the heading to be followed by the aircraft AC or the route to be followed by the aircraft AC. In the example of FIG. 2, the part of path TR, just in front of the current position of the aircraft AC, is a straight line coinciding with the characteristic element C1 which corresponds to the centerline of the taxiway 5. In this example, the part of path TR corresponds therefore either to a straight line coinciding with the centerline C1 (and for example representing a part of the route to be followed by the aircraft AC) or to a heading corresponding to the heading along which said centerline C1 is oriented.

The surveillance unit 8 comprises a set 11 of data sources allowing the system 1 to receive data on the external environment of the aircraft AC. The set 11 comprises data sources, specified hereinbelow, with which the aircraft AC is generally already equipped.

The monitoring unit 8 also comprises a data processing device 12 (PROCESS1 for “data Processing device”) configured to perform different processing operations and computations specified hereinbelow. The data processing device 12 is linked to the different data sources of the set 11.

In a particular embodiment, the set 11 of data sources comprises an optical detection system 13, preferably a visual detection system.

This optical detection system 13 which is linked via a link 14 to the data processing device 12 comprises, as represented in FIG. 1:
an imaging device 15 (IMAG for “imaging device”) configured to take images of the environment outside of the aircraft AC; and
an image processing device 16 (PROCESS2 for “image Processing device”) configured to process at least some of the images taken by the imaging device 15 so as notably to detect, if necessary, a characteristic element Cn (n being an integer) or Bm (m being an integer), when this characteristic element Cn or Bm (specified hereinbelow) is represented on at least one of the images processed (that is to say of which a representation is located on the image).

Preferably, the imaging device 15 takes images in the visible and the system of 13 then corresponds to a visual detection system. As a variant, it can also take images from radiations having other wavelengths, for example in the infrared, notably in cases of reduced visibility.

Furthermore, the image processing device 16 implements at least one of the following techniques, specified hereinbelow:
a technique using artificial intelligence;
an image processing technique.

Furthermore, in a particular embodiment, the set 11 also comprises, as represented in FIG. 1, an odometer 18 (ODOM for “Odometer”), linked via a link 19 to the data processing device 12 and configured to implement a visual odometry in order notably to determine, in the normal way, the movement or the dynamics (position and speed) of the aircraft AC.

Moreover, in a particular embodiment, the set 11 comprises a radar 20 linked via a link 21 to the data processing device 12 and configured to detect a limit (such as the limit C5, C6 of FIG. 2) between a zone provided with a coating for taxiing and a zone (such as the zone Z1, Z2 of FIG. 2) without any such coating, as specified hereinbelow.

Moreover, in a particular embodiment, the surveillance unit 7 also comprises a set 22 of data sources S1, . . . , Si (DATA1, . . . , DATAi for “Data sources”), i being an integer. This set 22 comprises at least one of the following usual data (or information) sources S1 to Si, with which the aircraft AC is generally already equipped:
an inertial reference system;
a satellite positioning system;
an odometer;
a tachymeter;
an optoelectronic sensor which can, for example, correspond to the optical detection system 13.

In addition, in this particular embodiment, the data processing device 12 (which is linked via a link 23 to the set 22) is configured to determine a so-called absolute position of the aircraft, using at least one (position) information item from at least one of said data sources S1 to Si.

In a particular embodiment, the data processing device 12 determines a consolidated relative position using data (or information) from several data sources S1 to Si of the set 22.

Moreover, in a particular embodiment:
at least one of the data sources of the set 11 is configured to generate data relating to at least one of the following characteristic elements Cn of the traffic lane, specified hereinbelow:
a centerline of the traffic lane;
an edge line of the traffic lane;
a limit between a zone provided with a coating for taxiing and a zone with no such coating; and
the data processing device 12 is configured to process these data received from the data source of the set 11 so as to determine the current relative position of the aircraft with respect to the characteristic element Cn and to deduce, if necessary, a current deviation of the aircraft with respect to the path TR to be followed, said current deviation representing the assistance information item.

Furthermore, in another particular embodiment:
at least one of the data sources of the set 11 is configured to receive data relating to one or more characteristic elements Bm (relating to a taxi-holding position of a traffic lane corresponding to a runway of the airport), comprising a mandatory characteristic element corresponding to a stop marking on the ground, and possibly one or more of the following characteristic elements:
an auxiliary marking on the ground;
a light indicator;
an instruction marking or panel; and
the data processing device 12 is configured to determine, from these data received from the data source of the set 11 and a possible authorization from air traffic control, an authorization or a prohibition to enter onto the runway, said authorization or said prohibition (to enter onto the runway) representing the assistance information item.

Moreover, in a first embodiment, the assistance unit 9 comprises an information presentation device 24 (INFORM for “Information presentation device”). This information presentation device 24 is configured to present one or more assistance information items, namely piloting assistance and/or ground navigation assistance information, in the cockpit of the aircraft AC. Such assistance information can, notably, make the pilot aware of the situation concerning the aircraft, in particular with respect to the path to be followed. In a preferred embodiment, the information presentation device 24 comprises at least one standard display device of the aircraft, which is able to present assistance information, via a display of head-up type and/or a display of head-down type. The information presentation device 24 can also comprise a standard device of the aircraft, to present (issue) the assistance information in the form of sound messages in the cockpit.

Furthermore, in a second embodiment, as a variant or complementing said first embodiment, the assistance unit 9 comprises an assistance system 25 configured to implement an at least partially automatic piloting of the aircraft AC.

In this second embodiment, the assistance system 25 of the assistance unit 9 comprises one of the following devices:
in a first variant, a maintaining device 26 configured to have the aircraft automatically maintain a heading to be followed;
in a second variant, a following device 27 configured to have the aircraft automatically follow a straight line;
in a third variant, a following and management device 28 configured to have both the aircraft automatically follow a straight line and an automatic management of the speed of the aircraft; or
in a fourth variant, an automatic piloting device 29 configured to implement an automatic piloting of the aircraft to follow a route.

Although, for the purposes of simplification of the drawing, the four assistance devices 26, 27, 28 and 29 are represented schematically in FIG. 1, the assistance system 25 of the assistance unit 9 comprises only one of these assistance devices 26, 27, 28 and 29 (ASSIST 1 to ASSIST 4 for «Assistance device») depending on the variant embodiment which is implemented in the system 1.

The system 1 can thus implement a presentation of information via the information presentation device 24 and/or an assistance (more or less automated) via the assistance system 25.

Thus, as will be described in more detail hereinbelow, the system 1 is able, during a taxiing phase of the aircraft AC, to assist the pilot of the aircraft AC to have said aircraft AC follow the path (heading or route) that it must follow.

In the context of the present invention, an assistance, implemented by the system 1, corresponds notably to one of the following types of assistance:
assistance to the pilot in terms of speed and following in a straight line;
assistance to the pilot in speed and trajectory-following terms (straight lines and turns); and
entirely automated assistance.

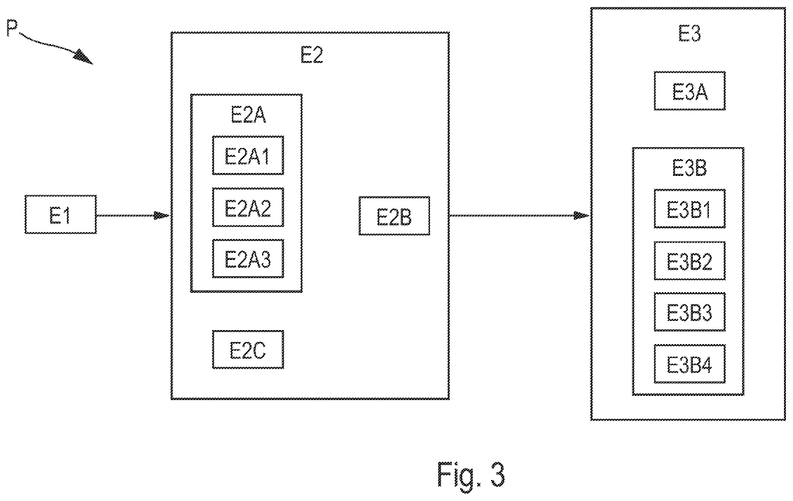

The system 1, as described hereinabove, is intended to implement an assistance aid method P as presented hereinbelow with reference to FIG. 3.

Said method P comprises the following steps:
a path reception step E1, implemented by the reception unit 7 (FIG. 1), at least to receive at least a part of a path TR to be followed by the aircraft AC on the airport 2 (FIG. 2);
a surveillance step E2, implemented by the surveillance unit 8, at least to survey the airport 2 so as to be able to detect at least one characteristic element of a traffic lane 5 taken by the aircraft AC, to determine a current relative position of the aircraft AC with respect to the characteristic element detected, and to deduce therefrom at least one assistance information item; and
an assistance step E3, implemented by the assistance unit 9, at least to assist the pilot of the aircraft when taxiing on the airport by taking into account at least said assistance information item deduced in the surveillance step E2.

The system 1 is activated and the method P is implemented when the aircraft AC is in a taxiing phase. This activation (of the system 1 for the implementation of the method P) is performed automatically, the system 1 having automatic and standard knowledge of how to implement a taxiing phase. Furthermore, the system 1 is deactivated at the end of the taxiing phase. This deactivation is performed either automatically or manually by the pilot by actuating a deactivation element (not represented) of the system 1.

The reception step E1 comprises the reception, using the reception unit 7, of an information item indicating at least a part of the path TR to be followed, that is to say at least the part of path TR that the aircraft must follow from its current position. This information item can correspond to a heading or to a route.

To do this, in a particular embodiment, the reception unit 7 is configured to, in the path reception step E1, insert (or enter) the route into the system 1, either by receiving it directly from Air Traffic Control ATC via a corresponding message received via a data transmission link, or by performing an extraction (of the entry authorization) of an audio message from air traffic control intended for the pilot of the aircraft, using a voice transcription as specified hereinbelow.

In addition or as a variant, the reception unit 7 is configured to allow the pilot to manually insert (or enter) the path to be followed (route or heading) into the system 1, in the path reception step E1, and also to modify a path already entered into the system 1.

In a preferred embodiment, the method P uses a standard dynamic map of the airport.

Moreover, in a preferred embodiment, the surveillance step E2 comprises at least:
a data reception step E2A to receive data relating, notably, to at least one characteristic element of the traffic lane taken by the aircraft AC; and
a data processing step E2B to process the data received in the data reception step E2A and to determine at least one assistance information item.

The data reception step E2A comprises an optical detection step E2A1 implemented by the optical detection system 13. This optical detection step E2A1 comprises:
an imaging substep, implemented by the imaging device 15, to take images of the environment outside of the aircraft AC. The imaging device 15 provides, in the usual manner, 2D images of the scene outside and in front of the aircraft, and does so in the visible spectrum or in the infrared spectrum (notably in cases of low visibility); and
an image processing substep, implemented by the image processing device 16, to process at least some of the images taken in said imaging substep so as to detect, if necessary, a characteristic element, when this characteristic element is represented on at least one of the images processed.

The optical detection step E2A1 is implemented to detect all the characteristic elements (visual) which are likely to be taken into account in the implementation of the surveillance step E2.

To implement the optical detection step E2A1, the aircraft AC is equipped with one or more imaging devices 15, namely preferably cameras, to take (or capture) the images of the outside environment (in the imaging substep) while the aircraft AC is taxiing and provide the imaging device 16 with the captured images.

In a first variant embodiment, the image processing substep implements a technique using artificial intelligence. In this first variant, one or more artificial intelligence algorithms incorporated in the image processing device 16 use an image as input, and, if necessary, detect and locate a representation of the characteristic element in the image. Various artificial intelligence approaches can be used, including “machine learning” and/or “deep learning” techniques.

In a preferred embodiment, in which the image processing device 16 is based on artificial intelligence using a machine learning system, the machine learning uses, for the learning, data collected beforehand which are representative of a variety of situations and situations that conform to those which can be encountered by an aircraft travelling on an airport. To do this, cameras are installed on one or more aircraft. These cameras are identical to those used by the system 1 or at the very least have technical characteristics close to those used by the system 1. In addition, these cameras are installed on this aircraft or these aircraft at the same locations, or at locations that are as close as possible, as those of the cameras of the system 1. Images are taken when one or more duly equipped aircraft is or are taxiing on airports, and the images taken are stored. All of the stored images are then collected. The imagings are done on different airports, for different and varied brightness conditions (for example daytime, nighttime, et cetera) and different and varied weather conditions (for example sunny weather, rain, snow, et cetera) so as to take account of all of the main situations and conditions likely to be encountered by an aircraft equipped with the system 1. All of the images thus collected are used by the learning system of the artificial intelligence of the image processing device 16.

Different artificial intelligence-based processing techniques can provide the information that is sought. Examples that can be cited, by way of illustration, include:
an object detection. In this case, if a characteristic element is represented in the image, the artificial intelligence algorithm detects it and locates it spatially in the image. These operations can be performed by taking into account notably the geometry, the color, the symmetry, and other such factors, with standard and machine learning algorithms, or be implemented fully by a deep learning algorithm which is previously trained in order to find the best characteristics for detecting the objects;
a segmentation of the image. In this case, each pixel of the image is classed as forming part or not forming part of a characteristic element, and if a characteristic element is represented in the image, all of the pixels relating to this characteristic element make it possible to detect it and locate it.

In a second variant embodiment, the image processing substep implements a standard, so-called image processing technique.

It is known that the image processing techniques process the pixels of the image, by using filters and standard signal processing techniques, to recover points of interest and geometric information in the image in order to check whether a characteristic element is represented in the image, and, if necessary, locate it spatially in the image.

Furthermore, in a third variant embodiment, the image processing substep implements both a technique (such as that described hereinabove) that uses artificial intelligence and an image processing technique (such as that also described hereinabove).

The calibration of the imaging device 15 (intrinsic and extrinsic parameters) then makes it possible for the image processing device 16 of the system 1 to determine the relative position of the aircraft AC with respect to the characteristic element detected.

At each imaging instant considered, the camera or cameras take a new image which is then processed. Thus, a trajectory of the aircraft can be obtained by taking into account the successive positions of the aircraft with respect to the characteristic element.

The optical detection step E2A1, implemented by the optical detection system 13, can be used notably to detect lines on the ground, as specified hereinbelow. Their specific characteristics (for example their width, their color, the continuous lines contrasting with the coating) can assist in detecting them and in following them.

Moreover, in a preferred embodiment, the data reception step E2A also comprises an odometry step E2A2. This odometry step E2A2 is implemented using the odometer 18, to perform a visual odometry in order to determine at least the position of the aircraft AC and, more globally, the movement (or the dynamics), namely both the position and the speed, of the aircraft AC.

The visual odometry makes it possible to estimate the position and the orientation of the aircraft AC by virtue of the movement captured by one or more standard optical sensors (or vision sensors).

In a particular implementation, the odometry (visual) step E2A2, performed at least by the odometer 18, comprises the following successive operations a) to f):
a) acquisition of successive images using at least one optical sensor mounted on the aircraft AC;
b) performance of a preprocessing (for example an elimination of distortion or filtering) on each image acquired;
c) detection of characteristics (for example corners, lines, protruding points) in the current image, that are made to correspond to the preceding image (in the succession of images) to construct an optical stream;
d) elimination of any aberrant value in the field of the optical stream;
e) estimation of the movement of the optical sensor from the optical stream; and
f) estimation of the movement (position and speed) of the aircraft, from the movement of the optical sensor and from known extrinsic calibration parameters of the optical sensor.

To do this, the odometer comprises one or more optical sensors for acquiring the successive images and at least one processing unit (incorporated in the odometer 18 of FIG. 1 or forming part of the data processing device 12) which is configured to implement the abovementioned operations b) to f).

The position and/or the movement of the aircraft, thus estimated, are used to assist in determining an assistance information item in the data processing step E2B. The data processing step E2B is configured to process these position data so as to determine an absolute position of the aircraft AC (that is to say a position of the aircraft AC on the airport 2, clearly defined as such) and/or a relative position of the aircraft AC with respect to a characteristic element.

Moreover, in a particular embodiment, the data reception step E2A also comprises a detection step E2A3 comprising the following operations:
detecting, using the radar 20, a limit C5, C6 (FIG. 2) between a zone provided with a coating for taxiing on the traffic lane used (for example the taxiway 5 in the example of FIG. 2) and a zone Z1, Z2 without any coating for taxiing; and
determining a current relative position, namely the relative position of this limit C5, C6 (thus detected) with respect to the current position of the aircraft AC.

Such a current relative position information item is received (via the link 21) and is used by the data processing device 12, in the data processing step E2B.

This information allows the data processing device 12 to check whether the aircraft AC is correctly positioned (namely centered) on the traffic lane 5.

This information can also be used by the data processing device 12, in addition to the information (notably position information) obtained in at least one of the steps E2A1 and E2A2, to determine a consolidated current relative position, which makes it possible to increase the accuracy of the current relative position of the aircraft.

Moreover, in a particular embodiment, the surveillance step E2 also comprises a data reception step E2C comprising the reception of position data of the aircraft, from at least one of the data sources S1 to Si of the set 22 (FIG. 1).

Preferably, in this second data reception step E2C, the system 1 receives position data from at least one of the following data sources of the set 22 of the aircraft AC:
an inertial reference system;
a satellite positioning system;
an odometer;
a tachymeter;
an optoelectronic sensor.

In a particular embodiment, the data processing step E2B is configured to process the position data, received in the data reception step E2C, so as to determine an absolute position of the aircraft AC, that is to say a position of the aircraft AC on the airport 2, clearly defined as such.

Furthermore, in a preferred embodiment, the data processing step A2B implements a data merging operation. This data merging operation merges the data received from at least two different data sources of the set 22, in the data reception step E2C. This data merging operation, of standard type, makes it possible to consolidate the data received, and notably to obtain a particularly accurate absolute position.

Moreover, in a particular embodiment, in the surveillance step E2:
the data reception step E2A comprises the reception of data relating to at least one characteristic element Cn of a traffic lane of the airport 2, and notably of the traffic lane 5 taken by the aircraft; and
the data processing step E2B processes the data received in the data reception step E2A so as to determine the current relative position of the aircraft AC with respect to this characteristic element C1 and deduces, if necessary, a current deviation of the aircraft with respect to the path to be followed. This current deviation of the aircraft AC, for example with respect to the centerline C1 of the taxiway 5 on which the aircraft AC is moving (FIG. 2), represents the assistance information item, which will be used in the assistance step E3 to assist the pilot of the aircraft, as specified hereinbelow.

In this particular embodiment, the characteristic element or elements Cn relating to a traffic lane comprise one of the following elements:
a centerline of the traffic lane, such as the centerline C1 of the taxiway 5, the centerline C9 of the runway 3 and the centerline C2 of the taxiway 6, as represented in FIG. 2;
an edge line of the traffic lane, such as the edge lines C3 and C4 of the taxiway 5 of FIG. 2;
a limit C5, C6, C7, C8 between a zone (taxiways 5 and 6) provided with a coating for taxiing on the traffic lane and a zone Z1, Z2 (FIG. 2) without any coating for taxiing, such as for example the limits C5 and C6 of the taxiway 5 and the limits C7 and C8 of the taxiway 6.

Furthermore, in another particular embodiment, in the surveillance step E2:
the data reception step E2A comprises the reception of data relating to one or more characteristic elements Bm, including the mandatory characteristic element B1, relating to a taxi-holding position P1, P2, P3 of a traffic lane corresponding to a runway 3, 4 of the airport 2 (FIG. 2); and
the data processing step E2B determines, from the data received in the data reception step E2A and a possible authorization from air-traffic control (received in the way specified hereinbelow), an authorization or a prohibition to enter onto the runway 3, 4.

This authorization or this prohibition (determined thus in the data processing step E2B) represents the assistance information item, which will be used in the assistance step E3 to assist the pilot of the aircraft, as specified hereinbelow.

The characteristic elements Bm relating to a taxi-holding position Pi therefore comprise at least the mandatory characteristic element B1. This mandatory characteristic element B1 is a stop marking on the ground. It conforms to a standard model which is mandatory for all the runways such as the runways 3 and 4. Usually, it is formed by a set comprising two straight segments 30A and 30B and two rows 30C and 30D of broken lines, parallel to one another and orthogonal to the centerline of the runway considered (such as the centerline 8 for example), as represented by way of illustration in FIG. 2 for the runway 3.

In a preferred embodiment, said characteristic element or elements Bm relating to a taxi-holding position Pi also comprise at least one of the following auxiliary characteristic elements, as represented in FIG. 2 for the taxi-holding position P1:
an auxiliary marking B2 on the ground, before the taxi-holding position P1;
a light indicator B3 associated with the stop marking on the ground (mandatory characteristic element B1) of the taxi-holding position P1;
a marking (on the ground) of instructions or an instruction panel B4 of the taxi-holding position P1.

The light indicators (capable of emitting a light, generally red, when on), such as the light indicator B3, provide visual information concerning the authorization from air-traffic control to enter or not onto the associated runway 3. They are positioned at the taxi-holding position P1 of the associated runway 3 and operate as follows:
when the light indicator or indicators B3 are on (emitting a red light), the aircraft AC does not have authorization to enter onto the runway 3; and
when the light indicator or indicators B3 are off, the aircraft AC has authorization to enter onto the runway 3.

The light indicators, such as the light indicator B3, at the taxi-holding positions are not however mandatory on all airports. Consequently, the absence of a light indicator that is on does not provide any indication as to a potential situation of incursion on the runway. Conversely, the detection of a light indicator that is on confirms the absence of authorization from air-traffic control to enter (penetrate) onto the associated runway.

In FIG. 2, also represented by way of illustration are:
a taxi-holding position P2 intended for an aircraft taxiing on the taxiway 6 before entering onto the runway 3; and
a taxi-holding position P3 intended for an aircraft taxiing on the taxiway 6 before entering onto the runway 4.

Regarding the authorization from air-traffic control (to enter onto a runway), which is used in the data reception step E2A, it can be entered manually by the pilot into the system 1, for example using the reception unit 7 another manual entry (or input) element. The pilot enters the authorization when it has been communicated to him or her by voice by air-traffic control on approaching the runway concerned.

As a variant or in addition, the authorization from air traffic control, which is used in the data reception step E2A, can be entered automatically into the system 1. To this end, an authorization from air-traffic control, issued via a voice message intended for the pilot, is recovered automatically by the reception unit 7 or another, automatic data entry element (not represented) in the system 1.

To do this, in a preferred embodiment, the reception unit 7 or this automatic entry element comprises, to automatically recover such an authorization:
at least one standard voice transcription algorithm (of STT type, STT standing for “Speech To Text”), based on the artificial intelligence. This voice transcription algorithm receives and processes the communications incoming from air traffic control intended for the pilot, and transcribes, in the usual manner, each voice message from an air-traffic controller into a text message; and
at least one standard information extraction algorithm, also based on the artificial intelligence. This information extraction algorithm processes, in the usual manner, the text messages (from air-traffic control) generated by the voice transcription algorithm, to extract therefrom the information on authorization to enter onto a runway. The authorization information thus extracted is communicated to the surveillance unit 8 and notably to the data processing device 12 (FIG. 1).

Next, the assistance step E3 of the method P, implemented by the assistance unit 9, assists the pilot of the aircraft AC, when taxiing on the airport 2, by taking into account at least the assistance information item or items deduced in the surveillance step E2.

To do this, in a first embodiment, the assistance step E3 comprises at least one information presentation step E3A. This step E3A presents, in the cockpit of the aircraft AC, using the information presentation device 24, one or more assistance information items (received from the surveillance unit 12), namely piloting assistance and/or ground navigation assistance information.

In a preferred embodiment, the information presentation device 24 comprises at least one display device which can present the assistance information in the cockpit of the aircraft AC, via a standard display of head-up type and/or a standard display of head-down type. The information presentation device 24 can also represent, on a map which is displayed, the path to be followed by the aircraft and the position of the aircraft with respect to this path.

In this step E3A, in a particular variant, the information presentation device 24 can also issue assistance information in the form of sound messages in the cockpit.

Furthermore, in a second embodiment, as a variant or complementing the first embodiment, the assistance step E3 comprises a step E3B to implement an at least partially automatic piloting of the aircraft.

Presented hereinbelow, in a nonlimiting manner, are several different possible variants for implementing the assistance step E3. These variants are presented in the form of substeps E3B1 to E3B4, each of which implements an assistance (more or less automated).

In a first particular embodiment, the assistance step E3B comprises a heading-maintaining substep E3B1. This substep E3B1 makes the aircraft automatically maintain a heading to be followed, received in the reception step E1.

To do this, in a particular embodiment, the maintaining device 26 uses assistance information received from the data processing device 12, and notably a heading deviation, and it automatically controls a standard piloting system (for example by generating appropriate piloting orders (or instructions) and communicating them to it) of the aircraft so as to cancel this heading deviation, and thus maintain a heading of the aircraft, as required.

This substep E3B1 is implemented according to one of two variants, namely either with a simultaneous control of the speed of the aircraft AC, or without simultaneous control of the speed of the aircraft AC. In the case of simultaneous control of the speed, the control of the speed is implemented either via a speed limiter, or by following a speed objective indicated (or entered) by the pilot.

In a second particular embodiment, the assistance step E3B comprises a straight-line-following substep E3B2. This substep E3B2 makes the aircraft automatically follow a straight line, received in the reception step E1.

To do this, in a particular embodiment, the following device 27 uses assistance information received from the data processing device 12, and notably a deviation with respect to the centerline C1 of the taxiway 5 taken (FIG. 2), and it automatically controls a standard piloting system (for example by generating appropriate piloting orders (or instructions) and communicating them to it) of the aircraft so as to cancel this deviation, and thus to maintain the movement of the aircraft in a straight line, as required.

In a particular embodiment, the automatic following of a straight line by the aircraft has the following characteristics:
one or more of the data sources of the set 11 detect at least one characteristic line C1, C3, C4 (centerline and/or edge line) and/or a limit C5, C6 between a zone provided with a coating for taxiing on the traffic lane and a zone Z1, Z2 without any coating for taxiing (FIG. 2) and/or calculate the ground speed (notably by visual odometry) of the aircraft;
the data processing device 12 performs a merging of position data, from different data sources (inertial reference system and/or satellite positioning system and/or odometer and/or tachymeter and/or optoelectronic sensor) of the set 22, to provide an accurate absolute position of the aircraft AC on the ground; and
the following device 27 consolidates these two types of information to provide lateral guidance orders (or instructions) (to the piloting system of the aircraft) in order to perform an automatic following of the movement on the ground of the aircraft AC in a straight line.

Furthermore, in a third particular embodiment, the assistance step E3B comprises a straight-line following and speed management substep E3B3. This substep E3B3 performs both an automatic following by the aircraft of a straight line, received in the reception step E1, and an automatic management of the speed of the aircraft.

To do this, in a particular embodiment, the following and management device 28 uses assistance information received from the data processing device 12, and notably a deviation with respect to the centerline C1 of the taxiway 5 taken (FIG. 2) as well as speed indications, and it automatically controls a standard piloting system (for example by generating appropriate piloting orders (or instructions) and communicating them to it) of the aircraft so as to, simultaneously, cancel this deviation and thus maintain the movement of the aircraft in a straight line as required, and adapt the speed of the aircraft appropriately.

In a particular embodiment, the substep E3B3 has the following characteristics:
the system 1 obtains the route to be followed by the aircraft from the dynamic map of the airport (which is, for example, inserted into the system 1 or received via the reception unit 7) and from the route inserted from instructions from air traffic control (either manually by the pilot, or automatically by voice synthesis) using the reception unit 7 configured appropriately;
by using the route entered and all the data concerning the aircraft AC, the system 1 determines and supplies speed instructions, for example by asking to reduce the speed before a turn, et cetera; and
by using the route entered, the system 1 determines and supplies lateral guidance instructions:
either by using one or more data sources of the set 11 to detect a characteristic line C1, C3, C4 (centerline and/or edge line) and/or a limit C5, C6 between a zone provided with a coating for taxiing on the traffic lane and a zone Z1, Z2 without any coating for taxiing (FIG. 2);
or by using a merging of position data, from different data sources (inertial reference system and/or satellite positioning system and/or odometer and/or tachymeter and/or optoelectronic sensor) of the set 22, to provide an accurate absolute position of the aircraft AC on the ground.

The speed and lateral guidance instructions (or orders), thus obtained, are then applied automatically to a standard automatic piloting system of the aircraft.

Moreover, in a fourth particular embodiment, the assistance step E3B comprises an automatic piloting substep E3B4. This automatic piloting substep E3B4 implements an automatic piloting of the aircraft to follow a route, received in the reception step E1.

To do this, in a particular embodiment, the automatic piloting device 29 uses assistance information received from the data processing device 12, to manage piloting (lateral guidance and speed management) instructions (or orders) which are applied automatically to the aircraft.

In a particular embodiment, the substep E3B4 has the following characteristics:
the system 1 obtains the route to be followed by the aircraft from the dynamic map of the airport and from the path automatically inserted from instructions from air traffic control, using an automatic voice transcription;
the system 1 automatically obtains an information item concerning an authorization to enter (or not) onto a runway, using an automatic voice transcription of the instructions given vocally by air traffic control to the pilot of the aircraft and it automatically detects, via an optical detection, characteristic elements B1 to B4 relating to a taxi-holding position P1, P2, P3 of a traffic lane corresponding to a runway 3, 4 of the airport 2 to be able to detect the taxi-holding position P1, P2, P3 and authorize or not authorize the aircraft AC to enter onto the runway 3, 4;
the system 1 determines an accurate absolute position of the aircraft AC on the ground, by using a merging of position data, from different data sources (inertial reference system and/or satellite positioning system and/or odometer and/or tachymeter and/or optoelectronic sensor) of the set 22;
from the above data, the system 1 determines and supplies speed instructions and lateral guidance instructions.

The speed and lateral guidance instructions (or orders), thus obtained, are then applied automatically to a standard automatic piloting system of the aircraft.

The system 1 and the method P, as described hereinabove, offer numerous advantages. In particular:
they are able to assist the pilot of the aircraft during the taxiing phase, to assist him or her in having the aircraft follow the path (heading or route) that it must follow; and
this assistance can be implemented according to one of a plurality of different assistance modes, more or less automated, that is to say requiring a lesser or greater intervention from the pilot.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for assisting a pilot of an aircraft when the aircraft is taxiing on a traffic lane of an airport, the method comprising:
a surveillance step (E2), implemented by a surveillance unit, at least to survey the airport so as to be able to detect at least one characteristic element of a traffic lane of the airport, to determine a current relative position of the aircraft (AC) with respect to the characteristic element detected, and to deduce therefrom at least one so-called assistance information item, the surveillance step (E2) comprising a data reception step (E2A) comprising at least one odometry step (E2A2) at least to implement a visual odometry in order to determine at least the position of the aircraft (AC) making it possible to obtain said current relative position of the aircraft (AC); and
an assistance step (E3), implemented by at least one assistance unit, at least to assist the pilot of the aircraft (AC) when the aircraft (AC) is taxiing on the airport in order to have the aircraft (AC) follow a path (TR), by taking into account at least said assistance information item.

2. The method as claimed in claim 1, further comprising:
a reception step (E1), implemented by a reception unit, at least to receive at least a part of the path (TR) to be followed by the aircraft (AC) on the airport (2).

3. The method as claimed in claim 2,
wherein the reception step (E1) comprises the reception of at least one of the following information items representing at least said part of path (TR):
the heading to be followed by the aircraft (AC); or
the route to be followed by the aircraft (AC).

4. The method as claimed in claim 1,
wherein the data reception step (E2A) further comprises at least one of the following steps:
an optical detection step (E2A1) comprising an imaging substep at least to take images of the environment outside of the aircraft (AC) and an image processing substep at least to process at least some of the images taken in said imaging substep so as to detect at least one characteristic element relating to a traffic lane, represented in one of said processed images; or
a radar detection step (E2A3) at least to detect a limit between a zone provided with a coating for taxiing on the traffic lane and a zone without any coating for taxiing.

5. The method as claimed in claim 1,
wherein the surveillance step (E2) comprises at least one of the following steps:
a data reception step (E2C) comprising the reception of position information from at least one of the following data sources of the aircraft (AC): an inertial reference system, a satellite positioning system, an odometer, a tachymeter, an optoelectronic sensor, such position information making it possible to determine an absolute position of the aircraft (AC); or
a data processing step (E2B) at least to determine a consolidated absolute position of the aircraft (AC), by using position information from a plurality of different data sources.

6. The method as claimed in claim 1,
wherein the surveillance step (E2) comprises at least:
a data reception step (E2A) comprising the reception of data relating to at least one of the following characteristic elements of the traffic lane:
a centerline of the traffic lane;
at least one edge line of the traffic lane; or
at least one limit between a zone provided with a coating for taxiing on the traffic lane and a zone without any coating for taxiing; or
a data processing step (E2B) at least to process the data received in the data reception step so as to determine the current relative position of the aircraft (AC) with respect to the characteristic element and to deduce, if necessary, a current deviation of the aircraft (AC) with respect to the path to be followed, said current deviation representing the assistance information.

7. The method as claimed in claim 1,
wherein the surveillance step (E2) comprises at least:
a data reception step (E2A) comprising the reception of data relating to one or more characteristic elements comprising a mandatory characteristic element corresponding to a stop marking on the ground, said characteristic element or elements relating to a taxi-holding position of the airport; or
a data processing step (E2B) at least to determine, from the data received in the data reception step (E2A) and a possible authorization from air-traffic control, an authorization or a prohibition to enter onto the runway, said authorization or said prohibition representing the assistance information item.

8. The method as claimed in claim 1,
wherein the surveillance step (E2) uses a dynamic map of the airport.

9. The method as claimed in claim 1,
wherein the assistance step (E3) comprises at least one step (E3A) at least to present piloting assistance and/or ground navigation assistance information in the cockpit of the aircraft (AC).

10. The method as claimed in claim 1,
wherein the assistance step (E3) comprises a heading-maintaining substep (E3B1) at least to have the aircraft (AC) automatically maintain a heading to be followed, received in the reception step (E1).

11. The method as claimed in claim 1,
wherein the assistance step (E3) comprises a straight-line-following substep (E3B2) at least to have the aircraft (AC) automatically follow a straight line, received in the reception step (E1).

12. The method as claimed in claim 1,
wherein the assistance step (E3) comprises a straight-line-following and speed management substep (E3B3) in order to have both the aircraft the aircraft (AC) automatically follow a straight line, received in the reception step (E1), and an automatic management of the speed of the aircraft (AC).

13. The method as claimed in claim 1,
wherein the assistance step (E3) comprises an automatic piloting substep (E3B4) at least to implement an automatic piloting of the aircraft (AC) to follow a route, received in the reception step (E1).

14. A system for assisting a pilot of an aircraft when the aircraft is taxiing on a traffic lane of an airport, the system comprising:
a surveillance unit configured to survey the airport so as to be able to detect at least one characteristic element of a traffic lane of the airport, to determine a current relative position of the aircraft (AC) with respect to the characteristic element detected, and to deduce therefrom at least one so-called assistance information item, the surveillance unit comprising at least one odometer at least to implement a visual odometry in order to determine at least the position of the aircraft (AC) making it possible to obtain said current relative position of the aircraft (AC); and
an assistance unit configured to assist the pilot of the aircraft (AC) when taxiing on the airport in order to have the aircraft (AC) follow a path (TR) by taking into account at least said assistance information item.

15. An aircraft, comprising:
at least one system as claimed in claim 14.
